(19) United States
(12) Patent Application Publication
(10) Pub. No.: US 2022/0092410 A1
(43) Pub. Date: Mar. 24, 2022

(54) ARCHITECTED LIBRARY INTERFACE FOR KERNEL FUSION

(71) Applicant: Advanced Micro Devices, Inc., Santa Clara, CA (US)

(72) Inventor: Benjamin Thomas Sander, Austin, TX (US)

(21) Appl. No.: 17/031,601

(22) Filed: Sep. 24, 2020

(51) Int. Cl. G06N 3/08; G06F 8/54; G06N 3/04

(52) U.S. Cl. CPC G06N 3/08; G06F 8/41; G06N 3/04; G06F 8/54

(57) ABSTRACT

Systems, apparatuses, and methods for implementing an architected library interface for kernel fusion are disclosed. A processor receives a first representation of a neural network and a vendor-supplied library. The vendor-supplied library is associated with a specific hardware target, and the library includes fusing points which allow a kernel to be called within an optimized operation. When a kernel is called using the fusing point within an optimized operation, the kernel performs one or more operations on the data being processed by the optimized operation. This allows multiple kernels to be executed without having to write data back to memory after each individual kernel. The processor generates an optimized version of the neural network by linking to fusing points within the vendor-supplied library. This reduces the number of memory accesses and increases the performance of the optimized version of the neural network when executed on the hardware target.

### BACKGROUND

### Description of the Related Art

An emerging technology field is machine learning, with a neural network being one type of a machine learning model. Neural networks have demonstrated excellent performance at tasks such as hand-written digit classification and face detection. Additionally, neural networks have also shown promise for performing well in other, more challenging, visual classification tasks. Other applications for neural networks include speech recognition, language modeling, sentiment analysis, text prediction, and others. However, neural networks often use significant amounts of processing and memory resources.

### BRIEF DESCRIPTION OF THE DRAWINGS

The advantages of the methods and mechanisms described herein may be better understood by referring to the following description in conjunction with the accompanying drawings, in which:

FIG. 1 is a block diagram of one implementation of a computing system.

FIG. 2 is a block diagram of one implementation of a neural network.

FIG. 3 is a block diagram of another implementation of a neural network.

FIG. 4 is a block diagram of one implementation of fusing points within a vendor-supplied library.

FIG. 5 is a generalized flow diagram illustrating one implementation of a method for optimizing a machine learning model.

FIG. 6 is a generalized flow diagram illustrating one implementation of a method for executing functions at fusing points.

FIG. 7 is a generalized flow diagram illustrating one implementation of a method for modifying data generated within a vendor-supplied library routine.

### DETAILED DESCRIPTION OF IMPLEMENTATIONS

In the following description, numerous specific details are set forth to provide a thorough understanding of the methods and mechanisms presented herein. However, one having ordinary skill in the art should recognize that the various implementations may be practiced without these specific details. In some instances, well-known structures, components, signals, computer program instructions, and techniques have not been shown in detail to avoid obscuring the approaches described herein. It will be appreciated that for simplicity and clarity of illustration, elements shown in the figures have not necessarily been drawn to scale. For example, the dimensions of some of the elements may be exaggerated relative to other elements.

Various systems, apparatuses, and methods for implementing an architected library interface for kernel fusion are disclosed herein. In one implementation, a processor receives a first representation of a neural network and a vendor-supplied library. The vendor-supplied library is associated with a specific hardware target (e.g., graphics processing unit (GPU)), and the library includes fusing points which allow a kernel to be called within an operation. When a kernel is called using the fusing point within an optimized operation, the kernel performs one or more operations on the data being processing by the optimized operation. This allows multiple kernels to be executed without having to copy data back and forth to and from memory after each individual kernel. The processor generates an optimized version of the neural network by linking the first representation of the neural network to fusing points within the vendor-supplied library. This reduces the number of memory accesses and increases the performance of the optimized version of the neural network when executed on the hardware target.

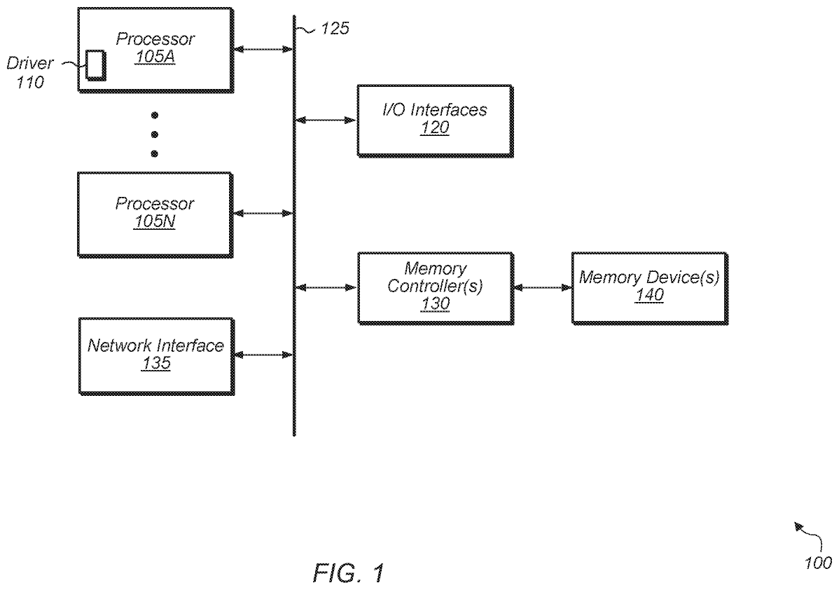

Referring now to FIG. 1, a block diagram of one implementation of a computing system 100 is shown. In one implementation, computing system 100 includes at least processors 105A-N, input/output (I/O) interfaces 120, bus 125, memory controller(s) 130, network interface 135, and memory device(s) 140. In other implementations, computing system 100 includes other components and/or computing system 100 is arranged differently. Processors 105A-N are representative of any number of processors which are included in system 100.

In one implementation, processor 105A is a general purpose processor, such as a central processing unit (CPU). In this implementation, processor 105A executes a driver 110 (e.g., graphics driver) for controlling the operation of one or more of the other processors in system 100. It is noted that depending on the implementation, driver 110 can be implemented using any suitable combination of hardware, software, and/or firmware. In one implementation, processor 105N is a data parallel processor with a highly parallel architecture. Data parallel processors include graphics processing units (GPUs), digital signal processors (DSPs), field programmable gate arrays (FPGAs), application specific integrated circuits (ASICs), and so forth. In some implementations, processors 105A-N include multiple data parallel processors.

Memory controller(s) 130 are representative of any number and type of memory controllers accessible by processors 105A-N. While memory controller(s) 130 are shown as being separate from processor 105A-N, it should be understood that this merely represents one possible implementation. In other implementations, a memory controller 130 can be embedded within one or more of processors 105A-N and/or a memory controller 130 can be located on the same semiconductor die as one or more of processors 105A-N. Memory controller(s) 130 are coupled to any number and type of memory devices(s) 140. For example, the type of memory in memory device(s) 140 includes high-bandwidth memory (HBM), non-volatile memory (NVM), Dynamic Random Access Memory (DRAM), Static Random Access Memory (SRAM), NAND Flash memory, NOR flash memory, Ferroelectric Random Access Memory (FeRAM), or others.

I/O interfaces 120 are representative of any number and type of I/O interfaces (e.g., peripheral component interconnect (PCI) bus, PCI-Extended (PCI-X), PCIE (PCI Express) bus, gigabit Ethernet (GBE) bus, universal serial bus (USB)). Various types of peripheral devices (not shown) are coupled to I/O interfaces 120. Such peripheral devices include (but are not limited to) displays, keyboards, mice, printers, scanners, joysticks or other types of game controllers, media recording devices, external storage devices, network interface cards, and so forth. Network interface 135 is used to receive and send network messages across a network (not shown).

In various implementations, computing system 100 is a computer, laptop, mobile device, game console, server, streaming device, wearable device, or any of various other types of computing systems or devices. It is noted that the number of components of computing system 100 varies from implementation to implementation. For example, in other implementations, there are more or fewer of each component than the number shown in FIG. 1. It is also noted that in other implementations, computing system 100 includes other components not shown in FIG. 1. Additionally, in other implementations, computing system 100 is structured in other ways than shown in FIG. 1.

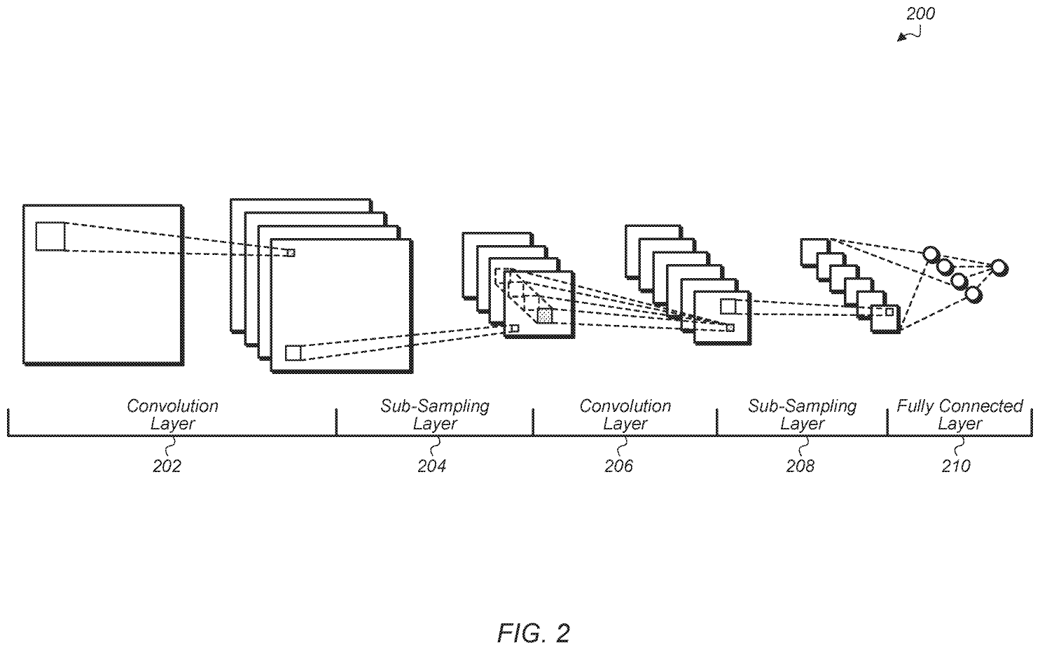

Turning now to FIG. 2, a block diagram of one implementation of a neural network 200 is shown. Neural network 200 includes convolution layer 202, sub-sampling layer 204, convolution layer 206, sub-sampling layer 208, and fully connected layer 210. In other implementations, neural network 200 can include other numbers and arrangements of layers. When implementing neural network 200 on a computing system (e.g., system 100 of FIG. 1), the performance of neural network 200 can be improved by using fusing points within vendor-supplied libraries to combine kernels. This can result in a reduction of memory accesses performed by the system when implementing neural network 200. Also, a reduction in power consumption is also possible by using the techniques described herein. Methods and mechanisms for taking advantage of fusing points within vendor-supplied libraries will be described throughout the remainder of this disclosure.

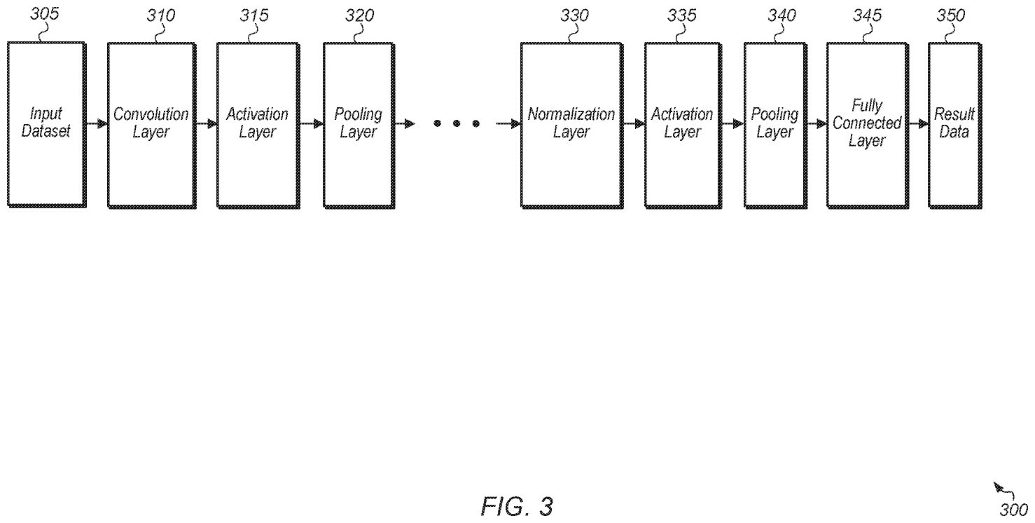

Referring now to FIG. 3, a block diagram of another implementation of a neural network 300 is shown. Neural network 300 illustrates another example of a neural network that can be implemented on a computing system (e.g., system 100 of FIG. 1). Neural network 300 includes at least convolution layer 310, activation layer 315, pooling layer 320, normalization layer 330, activation layer 335, pooling layer 340, fully connected layer 345 and any number of other layers. In other implementations, neural network 300 includes other arrangements of layers different from what is shown in FIG. 3. In one implementation, each layer of neural network 300 is implemented using a separate kernel. In some implementations, fusing points in a vendor-supplied library allow for two or more kernels to be combined to improve the performance of the neural network.

Neural network 300 processes input dataset 305 to generate result data 350. In one implementation, input dataset 305 is an image. In this implementation, result data 350 can be a classification of the image, such as determining to which type of category the image belongs. In other implementations, input dataset 305 includes any of various other types of data. In these implementations, result data 350 can be a recommendation, natural language selection, or include other types of outputs and/or classifications.

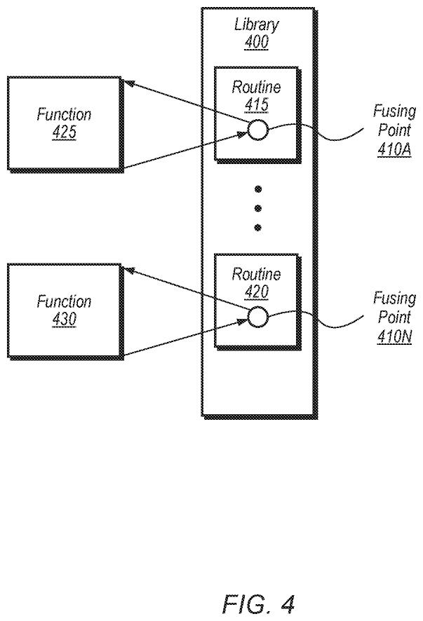

Turning now to FIG. 4, a block diagram of one implementation of fusing points within a vendor-supplied library 400 is shown. Vendor-supplied library 400 includes any number of routines 415, 420, and so on, with the number of routines varying from implementation to implementation. These routines 415 and 420 are optimized functions for executing operations on a given hardware target (e.g., GPU). The fusing points 410A-N are representative of any number of fusing points which are architected within the routines 415-420 of library 400. Examples of the use of fusing points 410A-N include, but are not limited to, loading data from memory, storing data to memory, performing operation(s) on data being loaded from memory, performing operation(s) on data being stored to memory, and others.

In one implementation, the fusing infrastructure of fusing points 410A-N includes a mechanism for a fused interface to perform setup and tear-down operations. For example, a fused operation may fuse to setup, load data, and tear-down fusing points in a coordinated fashion. In one implementation, the setup initializes the state of the interface while the loading step updates information in the state. The tear-down step exports or stores the fusing point state to another location (e.g., memory). For example, in one implementation, a fusion module computes the running average for all values that are being loaded. In other examples, the fusion module performs other calculations and/or operations on the data being loaded or the data being stored through a given fusing point 410A-N. Depending on the implementation, a fused routine on the load path is applied each time an element is loaded or the fused routine is applied only the first time an element is loaded. Applying a fused routine each time an element is loaded is useful when applying a transformation to input data, while applying a fused routine only the first time an element is loaded is useful for a case like computing an average of a plurality of elements. Other examples of fused routines are possible and are contemplated.

In one implementation, functions 425 and 430 are executed as part of a machine learning model application. For example, functions 425 and 430 are part of a neural network application in one implementation. It is noted that the terms “function” and “kernel” can be used interchangeably herein. In other implementations, functions 425 and 430 are executed as part of other types of applications. By using fusing points 410A-N within library 400, the performance of the resultant application can be improved. Additionally, the amount of memory traffic generated by the application can be reduced by using fusing points 410A-N to perform functions 425 and 430.

In one implementation, library 400 is provided in a higher level representation such as an intermediate representation. Library 400 includes architected fusing points 410A-N within routines 415 and 420, respectively. As used herein, an “architected fusing point” is defined as a location for inserting code, with the location included as part of the interface that is provided with the library. In one implementation, the architected fusing points 410A-N are provided as part of the higher level representation of library 400 so that a user or compiler can define various functions (e.g., functions 425 and 430) for accessing these fusing points. It is noted that the terms “architected fusing point” and “fusing point” can be used interchangeably herein.

Various types of neural network performance optimizations can be utilized when executing a neural network application. One example of a neural network performance optimization is the ability to optimize across neural network layers by combining kernels. Some of the layers might execute inside of vendor-supplied library 400, and some of the layers might execute with some other compilation or library path. Another example of a neural network performance optimization involves using high performance operations defined by a vendor-supplied library. In one implementation, these two neural network performance optimizations are combined by having a vendor supply a library having an architected interface with fusing points, such that the library supports the global optimizations. The architected interface has some number of well-defined points that code can be attached to for supporting global fusing opportunities. By supplying a library in a higher-level representation, it is possible for the library to include fusing points for attaching extra piece of codes.

For example, in one implementation, routine 415 is a matrix multiplication operation. In this example, function 425 is an activation function which is implementing a rectified linear unit (ReLU). For a ReLU, if the input x>0, ReLU returns x, and if x<0, ReLU returns 0. In a traditional system, the ReLU would be implemented after the matrix multiplication operation. The matrix multiplication operation would store every value to memory, then the ReLU would load the data back from memory, apply the ReLU function, and then store the data back to memory. This would cause a significant amount of memory traffic. With the approach illustrated in FIG. 4, before storing the data to memory, the ReLU operation is performed, then execution returns to the vendor supplied library routine 415, and then the data is stored. This results in a decrease in memory traffic.

In one implementation, library 400 is provided in an intermediate-level representation. In this implementation, a link step or a compiler operation is performed to combine routine 415 with function 425 at the fusing point 410A. In one implementation, a framework such as TensorFlow® or PyTorch® performs this link step to combine routine 415 with function 425 at the fusing point 410A. After the link step, the intermediate-level representation is converted into object code which can then be executed on the target machine. In one implementation, a graph compiler for compiling machine intelligence networks performs the above steps. The graph compiler analyzes the different layers of a neural network and determines how to fuse these layers together based on the availability and location of fusing points 410A-N.

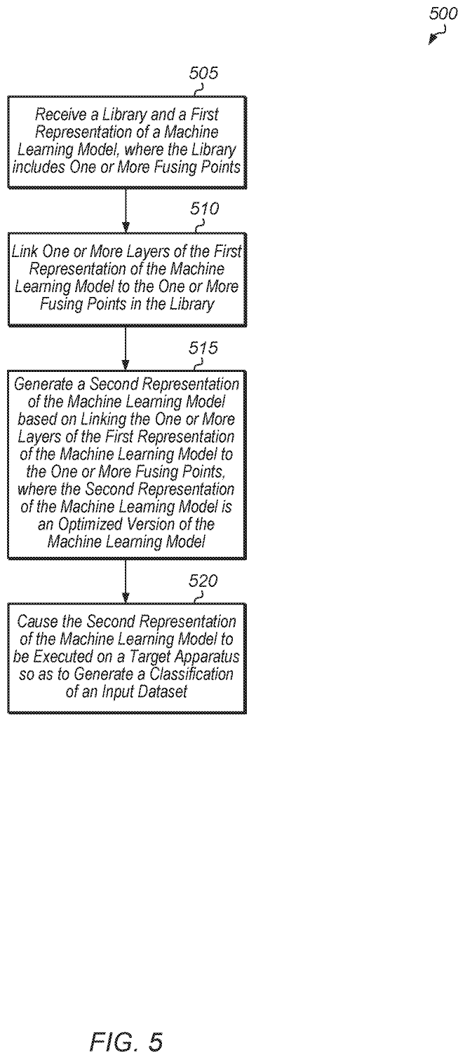

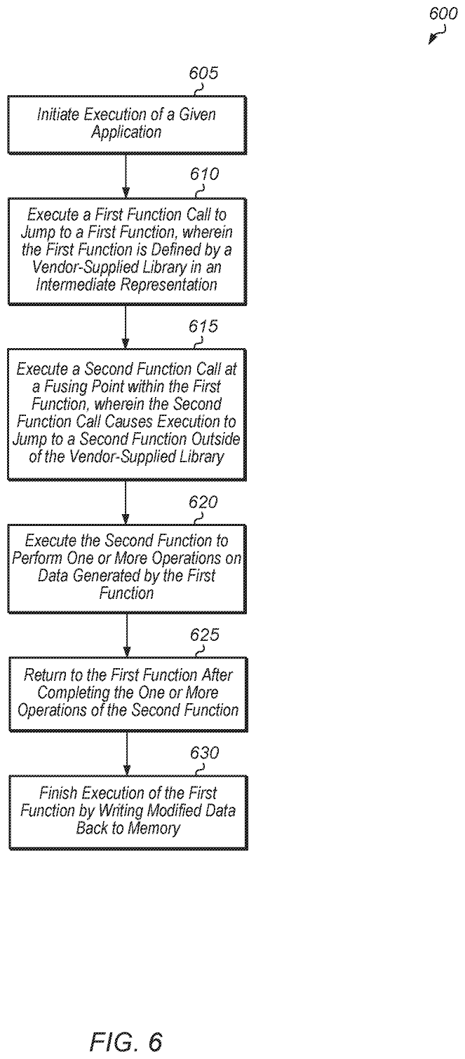

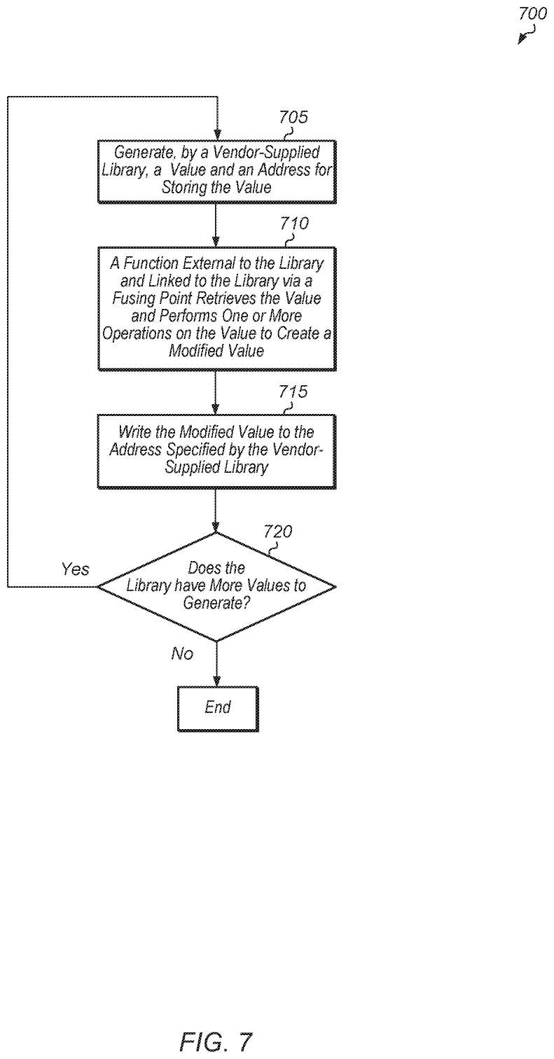

Referring now to FIG. 5, one implementation of a method 500 for optimizing a machine learning model is shown. For purposes of discussion, the steps in this implementation and those of FIG. 6-7 are shown in sequential order. However, it is noted that in various implementations of the described methods, one or more of the elements described are performed concurrently, in a different order than shown, or are omitted entirely. Other additional elements are also performed as desired. Any of the various systems or apparatuses described herein are configured to implement method 500.

A processor receives a library and a first representation of the machine learning model (e.g., neural network), where the library includes one or more fusing points (block 505). In one implementation, the library is a vendor-supplied library which is optimized to a particular hardware target. Next, the processor links one or more layers of the first representation of the machine learning model to one or more fusing points of the plurality of fusing points in the library (block 510). Then, the processor generates a second representation of the machine learning model based on linking the one or more layers of the first representation of the machine learning model to the one or more fusing points, where the second representation of the machine learning model is an optimized version of the machine learning model (block 515).

Next, the processor causes the second representation of the machine learning model to be executed on a target apparatus so as to generate a classification of an input dataset (block 520). After block 520, method 500 ends. By implementing method 500, the performance of the second representation of the machine learning model is improved by reducing the amount of memory traffic on the target apparatus.

Turning now to FIG. 6, one implementation of a method 600 for executing functions at fusing points is shown. A processor initiates execution of a given application (block 605). During execution of the given application, the processor executes a first function call to jump to a first function, where the first function is defined by a vendor-supplied library in an intermediate representation (block 610). As used herein, an “intermediate representation” is defined as a relatively high-level representation which enables a programmer or a framework to link code to the vendor-supplied library. An intermediate representation is at a higher level than assembly code, object code, or an executable binary. One example of an intermediate representation is low level virtual machine (LLVM) intermediate representation (IR). Other types of intermediate representations can also be used. In one implementation, the first function corresponds to a given layer of a neural network.

During execution of the instructions of the first function, the processor executes a second function call at a fusing point within the first function, wherein the second function call causes execution to jump to a second function outside of the vendor-supplied library (block 615). In one implementation, the second function corresponds to a different neural network layer from the layer corresponding to the first function. Next, the processor executes the second function to perform one or more operations on data generated by the first function (block 620). Then, the processor returns to the first function responsive to completing the one or more operations of the second function (block 625). Next, the processor finishes execution of the first function by writing modified data back to memory (block 630). After block 630, method 600 ends.

Referring now to FIG. 7, one implementation of a method 700 for modifying data generated within a vendor-supplied library routine is shown. A vendor-supplied library routine generates a value and an address for storing the value (block 705). A function external to the library and linked to the library via a fusing point retrieves the value and performs one or more operations on the value to create a modified value (block 710). In some cases, the operation does not modify the original value. For example, when implementing a rectified linear unit (or ReLU) activation function, if the original value is greater than zero, then the value is not modified. The output of a ReLU activation function is defined as y=max(0,x). In other words, the output “y” is equal to the maximum of either 0 or “x”. In other implementations, other types of functions are performed from the fusing point within the vendor-supplied library routine.

Next, the external function writes the modified value to the address specified by the vendor-supplied library (block 715). Then, the external function determines if the vendor-supplied library has more values to generate (conditional block 720). If the vendor-supplied library has more values to generate (conditional block 720, “yes” leg), then method 700 returns to block 705. If the vendor-supplied library does not have any more values to generate (conditional block 720, “no” leg), then method 700 ends.

In various implementations, program instructions of a software application are used to implement the methods and/or mechanisms described herein. For example, program instructions executable by a general or special purpose processor are contemplated. In various implementations, such program instructions are represented by a high level programming language. In other implementations, the program instructions are compiled from a high level programming language to a binary, intermediate, or other form. Alternatively, program instructions are written that describe the behavior or design of hardware. Such program instructions are represented by ahigh-level programming language, such as C. Alternatively, a hardware design language (HDL) such as Verilog is used. In various implementations, the program instructions are stored on any of a variety of non-transitory computer readable storage mediums. The storage medium is accessible by a computing system during use to provide the program instructions to the computing system for program execution. Generally speaking, such a computing system includes at least one or more memories and one or more processors configured to execute program instructions.

It should be emphasized that the above-described implementations are only non-limiting examples of implementations. Numerous variations and modifications will become apparent to those skilled in the art once the above disclosure is fully appreciated. It is intended that the following claims be interpreted to embrace all such variations and modifications.

What is claimed is:

1. An apparatus comprising:
a memory storing a library and a first representation of a machine learning model, wherein the library comprises a plurality of fusing points; and
a processor coupled to the memory, wherein the processor is configured to:
receive the library and the first representation of the machine learning model;
generate a second representation of the machine learning model based on linking the one or more layers of the first representation of the machine learning model to one or more fusing points; and
cause the second representation of the machine learning model to be executed on a target apparatus to generate a classification of an input dataset.

2. The apparatus as recited in claim 1, wherein the library is provided in an intermediate representation.

3. The apparatus as recited in claim 1, wherein the first representation of the machine learning model is a low level virtual machine intermediate representation (LLVMIR).

4. The apparatus as recited in claim 3, wherein the machine learning model is a neural network.

5. The apparatus as recited in claim 1, wherein linking one or more layers of the first representation of the machine learning model to the one or more fusing points of the plurality of fusing points in the library comprises:
linking to a first function within the library from a first layer of the first representation of the machine learning model; and
linking a first fusing point within the first function to a second layer of the first representation of the machine learning model.

6. The apparatus as recited in claim 5, wherein the first layer is a convolution layer, and wherein the second layer is an activation layer.

7. The apparatus as recited in claim 5, wherein the first function is a matrix multiplication operation, and wherein the second layer is an activation layer.

8. A method comprising:
receiving, by a processor, a library comprising a plurality of fusing points and a first representation of a machine learning model;
generating a second representation of the machine learning model based on linking the one or more layers of the first representation of the machine learning model to one or more fusing points; and
causing the second representation of the machine learning model to be executed on a target apparatus to generate a classification of an input dataset.

9. The method as recited in claim 8, wherein the library is provided in an intermediate representation.

10. The method as recited in claim 8, wherein the first representation of the machine learning model is a low level virtual machine intermediate representation (LLVMIR).

11. The method as recited in claim 10, wherein the machine learning model is a neural network.

12. The method as recited in claim 8, wherein linking one or more layers of the first representation of the machine learning model to the one or more fusing points of the plurality of fusing points in the library comprises:
linking to a first function within the library from a first layer of the first representation of the machine learning model; and
linking a first fusing point within the first function to a second layer of the first representation of the machine learning model.

13. The method as recited in claim 12, wherein the first layer is a convolution layer, and wherein the second layer is an activation layer.

14. The method as recited in claim 12, wherein the first function is a matrix multiplication operation, and wherein the second layer is an activation layer.

15. A system comprising:
a memory;
a first processor; and
a second processor configured to:
receive a library comprising a plurality of fusing points and a first representation of a machine learning model, wherein the library targets the first processor;
generate a second representation of the machine learning model based on linking the one or more layers of the first representation of the machine learning model to one or more fusing points; and
cause the second representation of the machine learning model to be executed on the first processor to generate a classification of an input dataset.

16. The system as recited in claim 15, wherein the library is provided in an intermediate representation.

17. The system as recited in claim 15, wherein the first representation of the machine learning model is a low level virtual machine intermediate representation (LLVMIR).

18. The system as recited in claim 17, wherein the machine learning model is a neural network.

19. The system as recited in claim 15, wherein linking one or more layers of the first representation of the machine learning model to the one or more fusing points of the plurality of fusing points in the library comprises:
linking to a first function within the library from a first layer of the first representation of the machine learning model; and
linking a first fusing point within the first function to a second layer of the first representation of the machine learning model.

20. The system as recited in claim 19, wherein the first layer is a convolution layer, and wherein the second layer is an activation layer.
